(19) United States
(12) Patent Application Publication
(10) Pub. No.: US 2022/0368129 A1
(43) Pub. Date: Nov. 17, 2022

(54) SYSTEM AND METHOD OF SECURE AUTHENTICATION AND DISCERNING CONTROL OF A UTILITY SYSTEM

(71) Applicant: Consolidated Edison Company of New York, Inc., New York, NY (US)

(72) Inventor: Abdo Y. Saad, Clifton, NJ (US)

(21) Appl. No.: 17/317,345

(22) Filed: May 11, 2021

(51) Int. Cl. H02J 3/14; H04L 29/06; G06K 9/62; G06N 20/00; G06Q 50/06

(52) U.S. Cl. CPC H02J 3/14; H04L 63/08; G06K 9/6256; G06N 20/00; G06Q 50/06; H02J 2203/10; H04L 2463/082

(57) ABSTRACT

A system and method of operating a utility system having a plurality of equipment for controlling the operation of the utility system is provided. The method includes receiving, from a user, a control action for at least one of the plurality of equipment and determining an impact of the control action on the operation of the utility system. It is determined, based at least in part on the impact of the control action, that a predetermined condition may occur as a result of executing the control action. An authentication check is performed on the user prior to executing the control action.

### BACKGROUND

The subject matter disclosed herein relates to a system and method of monitoring the operation of providing services by a utility, such as a public utility, and in particular to a system and method of securing actions performed by control systems of the utility.

Complex systems, such as public utility systems (e.g. electrical distribution, water distribution, natural gas distribution, district heating systems) or processing plants (e.g. oil refineries, food production) for example, often have a variety of equipment that may be remotely controlled. Traditionally, these systems required human operators to manually travel to the location of the equipment when a change was made. It should be appreciated that this was slow, costly, and did not allow the system operator to change the system operation to accommodate changing conditions. It should be appreciated that the centralization of the control function (whether in a single location or a plurality of locations) allows for increased efficiency, reduced costs and improved customer satisfaction.

The operation of these complex systems may be impacted by the transmission of control signals that interrupt the functioning of the system. For example, in an electrical utility system the opening of a circuit breaker may result in a loss of electrical power to customers. In some cases this type of activity may be needed, such as to de-energize a section of the electrical distribution network to allow service personnel to perform maintenance or repairs. It should be appreciated that if an operator inadvertently transmits a wrong command, or if an unauthorized user intentionally transmits a command, that unplanned outages of service may occur. In the case of an unauthorized user, attempts to restore service may be thwarted by the unauthorized user transmitting additional commands.

Accordingly, while existing monitoring and control systems are suitable for their intended purposes the need for improvement remains, particularly in providing a system that allows for categorization and selective validation of commands that may result in a service interruption.

### BRIEF DESCRIPTION

According to one aspect of the disclosure a method of operating a utility system having a plurality of equipment for controlling the operation of the utility system is provided. The method includes receiving, from a user, a control action for at least one of the plurality of equipment and determining an impact of the control action on the operation of the utility system. It is determined, based at least in part on the impact of the control action, that a predetermined condition may occur as a result of executing the control action. An authentication check is performed on the user prior to executing the control action.

In addition to one or more of the features described herein, or as an alternative, further embodiments of the method may include terminating the control action when the authentication check is not satisfied. In addition to one or more of the features described herein, or as an alternative, further embodiments of the method may include activating an alarm when the authentication check is not satisfied. In addition to one or more of the features described herein, or as an alternative, further embodiments of the method may include generating a log entry in a database when the authentication check is not satisfied.

In addition to one or more of the features described herein, or as an alternative, further embodiments of the method may include the predetermined condition being a load shedding event. In addition to one or more of the features described herein, or as an alternative, further embodiments of the method may include the predetermined condition being a network shutdown.

In addition to one or more of the features described herein, or as an alternative, further embodiments of the method may include the predetermined condition being a single event disconnect for at least one of the plurality of equipment. In addition to one or more of the features described herein, or as an alternative, further embodiments of the method may include determining when the user has issued greater than a predetermined number of control actions within a predetermined number of minutes. In addition to one or more of the features described herein, or as an alternative, further embodiments of the method may include performing the authentication check when the user has issued greater than the predetermined number of control actions within the predetermined number of minutes.

In addition to one or more of the features described herein, or as an alternative, further embodiments of the method may include the determining of the impact of the control action being performed by artificial intelligence system, the artificial intelligence system being based on a trained model. In addition to one or more of the features described herein, or as an alternative, further embodiments of the method may include training of the artificial intelligence system to determine an impact of a control action.

In addition to one or more of the features described herein, or as an alternative, further embodiments of the method may include the training that comprises: receiving training data that comprises control actions, utility system parameters, utility system conditions prior to the execution of the control action, and utility system conditions after execution of the control action; creating a model to predict the predetermined condition by analyzing the training data; evaluating utility system conditions in live data received from the utility system based on the trained model by the artificial intelligence system, the live data including control actions and utility system conditions; and outputting a result of the evaluation of the utility system conditions after execution of the control action, the result identifying a probability level of a predetermined condition occurring. In addition to one or more of the features described herein, or as an alternative, further embodiments of the method may include the training further comprises supervised training. In addition to one or more of the features described herein, or as an alternative, further embodiments of the method may include the authentication check comprises using multifactor authentication.

According to another aspect of the disclosure a utility system. The utility system comprising a plurality of control equipment coupled to the utility system. A plurality of sensors are coupled to the utility system. One or more processors operably coupled to the plurality of control equipment and a plurality of sensors, wherein the one or more processors are operable to: receive, from a user, a control action for at least one of the plurality of equipment; determine an impact of the control action on the operation of the utility system; determine, based at least in part on the impact of the control action, that a predetermined condition may occur as a result of executing the control action; and perform an authentication check on the user prior to executing the control action.

In addition to one or more of the features described herein, or as an alternative, further embodiments of the utility system may include the one or more processors being further operable to activate an alarm when the authentication check is not satisfied. In addition to one or more of the features described herein, or as an alternative, further embodiments of the utility system may include the predetermined condition having at least one of a load shedding event, a network shutdown, and a single event disconnect of one of the plurality of equipment.

In addition to one or more of the features described herein, or as an alternative, further embodiments of the utility system may include the determining of the impact of the control action being performed by artificial intelligence system, the artificial intelligence system being based on a trained model.

In addition to one or more of the features described herein, or as an alternative, further embodiments of the utility system may include a training of the artificial intelligence system that comprises: receiving training data that comprises control actions, utility system parameters, utility system conditions prior to the execution of the control action, and utility system conditions after execution of the control action; creating a model to predict the predetermined condition by analyzing the training data; evaluating utility system conditions in live data received from the utility system based on the trained model by the artificial intelligence system, the live data including control actions and utility system conditions; and outputting a result of the evaluation of the utility system conditions after execution of the control action, the result identifying a probability level of a predetermined condition occurring.

In addition to one or more of the features described herein, or as an alternative, further embodiments of the utility system may include the utility system parameters and utility system conditions being based at least in part on signals from the plurality of sensors.

These and other advantages and features will become more apparent from the following description taken in conjunction with the drawings.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a schematic illustration of a utility electrical distribution system;

FIG. 2 is a flow diagram of a method of operating the electrical distribution system of FIG. 1 according to one or more embodiments;

FIG. 3 is a flow diagram of another method of operating the electrical distribution system of FIG. 1 according to one or more embodiments;

FIG. 4 illustrates a system for artificial intelligence-based operation support for the electrical distribution system of FIG. 1 according to one or more embodiments;

FIG. 5 illustrates a computing system according to one or more embodiments;

FIG. 6 is a block diagram of training a model by the artificial system and using the model to categorize control commands in live data according to one or more embodiments;

FIG. 7 is a flow diagram of a method of operating the electrical distribution system of FIG. 1 using an artificial system according to one or more embodiments.

The detailed description explains embodiments of the disclosure, together with advantages and features, by way of example with reference to the drawings.

### DETAILED DESCRIPTION

Embodiments of the present disclosure provide for a system for operating a utility system, such as an electrical distribution network for example. Further embodiments provide for automatically categorizing a command signal and selectively authenticating user based on a predicted system response. Still further embodiments of the present disclosure facilitate an artificial intelligence (AI) system to be trained using supervised learning to categorize a command signal based on a predicted system response and authenticating the user based thereon. Further, in one or more embodiments of the present disclosure, the AI system can selectively continue the executions of the command signal in response to a validation of an authentication signal.

It should be appreciated that while aspects of this disclosure refer to a method and system for operating an electrical distribution system, this is for exemplary purposes and the claims should not be so limited. In other embodiments, other types of complex or interconnected systems may be operated in a similar manner, these systems may include, but are not limited to natural gas distribution systems, water distribution systems, steam distribution systems, food production facilities, oil refinery systems, railroad traffic control systems, and aircraft traffic control systems for example.

It should further be appreciated that embodiments herein provide for a system and method of providing a technical solution for improving security of a complex or interconnected system, such as an electrical distribution or transmission system for example, in an efficient manner based at least in part on the type of transaction or command that is being executed. As such, embodiments of the system and method provided herein improve security while minimizing or at least reducing the overhead or impact of the security measures on operations while simultaneously reducing, mitigating, or eliminating undesirable actions by unauthorized or malicious actor(s).

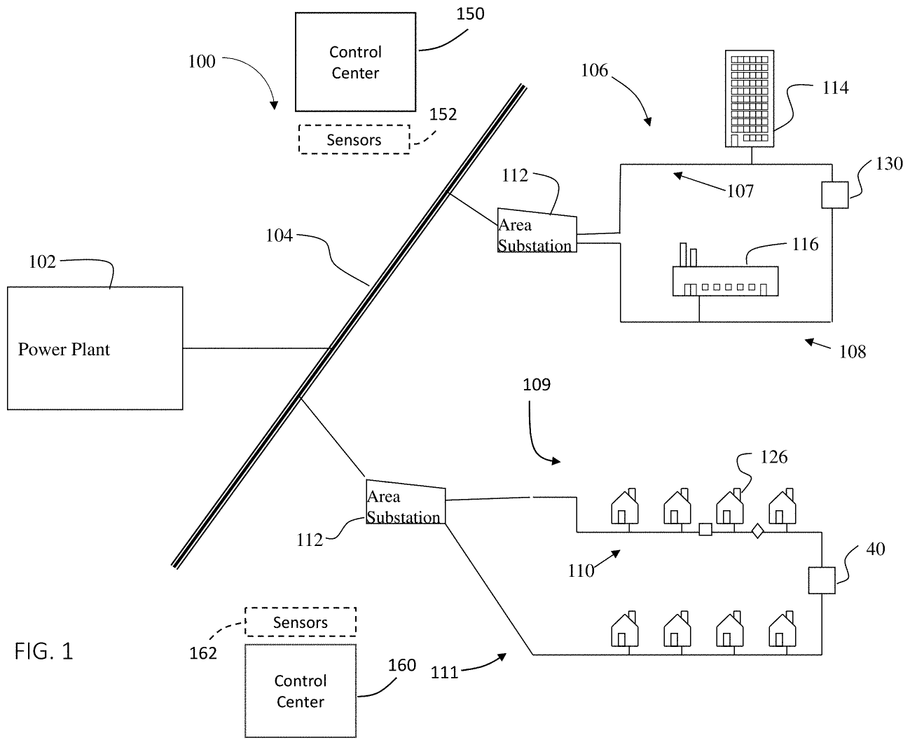

Referring now to FIG. 1, an embodiment is shown of a utility electrical distribution system 100. The utility system 100 includes one or more power plants 102 connected in parallel to a main transmission system 104. The power plants 102 may include, but are not limited to: coal, nuclear, natural gas, or incineration power plants. Additionally, the power plants 102 may include one or more facilities that generate electricity based on renewable energy sources, such as but not limited to hydroelectric, solar, or wind turbine power plants. It should be appreciated that additional components such as transformers, switchgear, fuses and the like (not shown) may be incorporated into the utility system 100 to provide for the efficient operation of the system. The utility system 100 is typically interconnected with one or more other utility networks to allow the transfer of electrical power into or out of the utility system 100.

The main transmission system 104 typically consists of high transmission voltage power lines, anywhere from 69 KV to 500 KV for example, and associated transmission and distribution equipment which carry the electrical power from the point of production at the power plants 102 to the end users located on local electrical distribution systems 106, 109. The local distribution systems 106, 109 are connected to the main distribution system by area substations 112 which reduce transmission voltage to distribution levels such as 13 KV, 27 KV or 33 KV. Area substations 112 typically contain one or more transformers, switching, protection, and control equipment. Area substations 112 all include circuit breakers to interrupt faults such as short circuits or over-load currents that may occur. Substations 112 may also include equipment such as fuses, surge protection, controls, meters, capacitors, and load tap changers for voltage regulation.

The area substations 112 connect to one or more local electrical distribution systems, such as local distribution system 106, for example, that provides electrical power to a commercial area having end users such as an office building 114 or a manufacturing facility 116. In an embodiment, the area substation 112 may have two or more feeder circuits that provide electrical power to different feeder circuit branches 107, 108 of the local distribution system 106.

The residential distribution system 109 includes one or more residential buildings 126 and light industrial or commercial operations. Similar to the commercial distribution network 106, the residential system 109 is divided into multiple branch feeders 110, 111 that are fed by the substation 112. In an embodiment, the local distribution system 109 is arranged such that approximately up to 6 MVA of power is provided on each branch circuit for electrical loads such as residential buildings.

In each of the local distribution systems 106, 109, there may be disconnect equipment 40, 130, sometimes referred to as a recloser, that allows the electrical separation of different parts of the local distribution system 106, 109. In this way if there is a loss of service on one part, such as section 108 or section 111 (e.g. a tree falls during a storm), by opening the disconnect equipment 40, 130 service may be returned to the other sections 107, 110.

It should be appreciated that the utility system 100 may have one or more control centers 150, 160. The control center 150 may regulate and control the flow of electrical power through the main transmission system 104, while the control center 160 may control the flow of electrical power in the distribution systems 106, 109. It should be appreciated that the control centers 150, 160 may be connected to different pieces of control equipment within their respective systems 104, 106, 109 that allows operators within the control systems to effect changes in the systems 104, 106, 109 to adapt the systems 104, 106, 109 to different operating conditions. The control centers 150, 160 may further receive signals from a network of sensors 152, 162 that measure parameters and conditions on the utility system 100. At least some of the sensors 152, 162 may be coupled to or integral with the control equipment within the systems 104, 106, 109. The control centers 150, 160 may be connected to the control equipment, such as disconnect equipment 40, 130 for example, and sensors 152, 162 by wired or wireless communications mediums.

It should be appreciated that changing the operating state of equipment, or combinations of equipment, that are connected to the utility system 100 may result in a loss of service for customers, or potentially for the damaging of other equipment in the utility system 100. Thus, if an operator or an unauthorized user issues certain categories of commands, it may have undesired effects on the utility system 100 or portions thereof. It should be appreciated that in a complex system, such as utility system 100, only a small number of commands may results in undesired effects relative to the number of commands that are being executed.

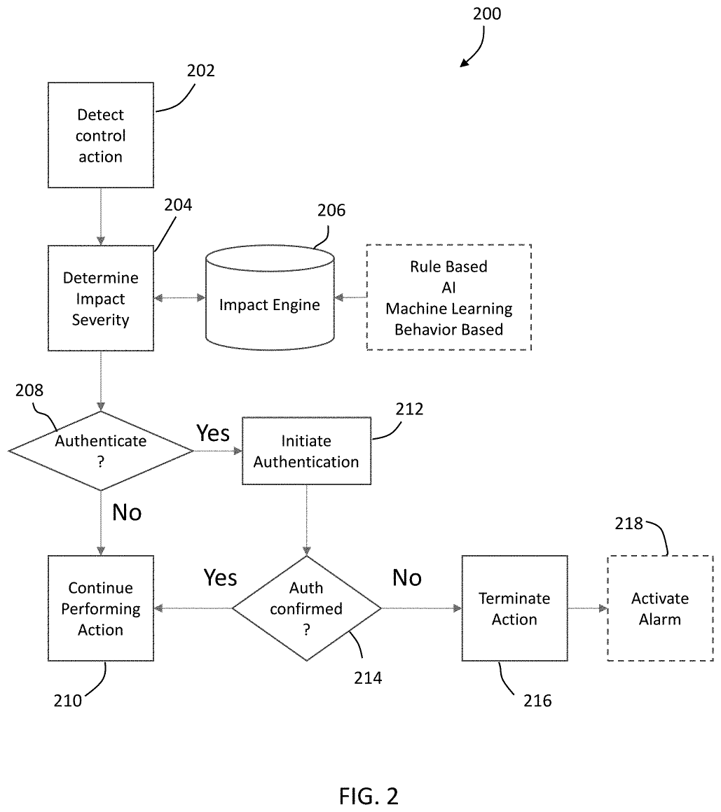

Referring now to FIG. 2, an embodiment is shown of a method 200 for operating a system, such as utility system 100 or portions thereof for example. The method 200 begins in block 202 where a control action is detected. It should be appreciated that a control action may be a command initiated by a single user/operator, a plurality of commands initiated within a short period of time by a single user/operator, or a plurality of commands initiated within a short period of time by multiple users/operators. The method then proceeds to block 204 where the impact severity of executing the command(s) would have on the electrical distribution system, such as would the execution result in a risk of loss of service or damage to equipment for example. In an embodiment, the system includes an impact engine 206 that categorizes the control action based on a predicted severity. The impact engine 206 may be rule based, use artificial intelligence, machine learning, or be behavior based to predict a probability of a loss of service or damage to equipment.

The method 200 then proceeds to query block 208 where it is determined whether an authentication process should be initiated. When the probability of a control action resulting in a loss of service is less than a threshold, the query block 208 results in a negative and the control action is performed in block 210. In some embodiments, the loss of service may have to be above a threshold before the authentication is performed. For example, a 70% probability of loss of service to a single residential customer may not result in an authentication, but a 51% probability of a loss of service to a 1000 residential customers may initiate the authentication.

When the query block 208 results in an undesired operating condition (e.g. a high probability of loss of service to a large number of customers), the method 200 proceeds to block 212 where authentication is initiated. In the example embodiment, the authentication method is a multifactor authentication method. Multifactor authentication is a method that verifies a user by requiring two or more factors/evidence. The factors may include knowledge, possession, inherence, or location for example. The knowledge factor is something only the user knows, such as a password/code for example. The possession factor is something only the user has, such as a cellular phone or a security token. The inherence factor is a physical characteristic of the user, such as biometrics for example. The location factor is a somewhere the user is, such as connected to a specific network or a GPS location for example.

The method 200 then proceeds to query block 214 where authentication is confirmed. Where the user successfully provides the correct factors (when using a multifactor system), the query block 214 returns a positive (e.g the authentication check is satisfied) and the method 200 proceeds to block 210 where the action is performed. When the user does not provide the correct factors (e.g. the authentication check is not satisfied), the method 200 proceeds to block 216 where the control action is terminated. The method 200 may then proceed to optional block 218 where an alarm may be activated to alert other users/operators of an attempt to perform an undesired operating condition. In some embodiments, block 218 may be context sensitive, such as executing based on the severity of the undesired condition that could have occurred for example.

It should be appreciated that while embodiments herein may refer to the authentication of the user using multifactor authentication, this is for example purposes and the claims should not be so limited. In other embodiments other types of authentication now in use or later developed may be used, such as but not limited to blockchain, certificate, biometric, and token based authentication systems for example.

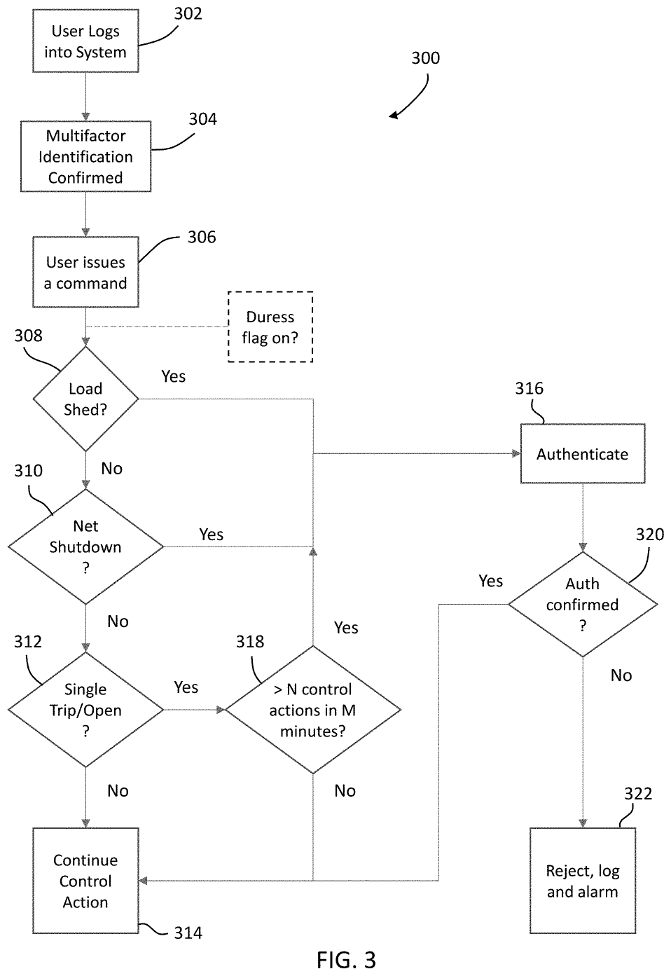

Referring to FIG. 3, another method 300 is shown for operating the electrical distribution system of FIG. 1. In this embodiment, the method 300 starts in block 302 where the user logs into the control system, such as in control centers 150, 160 for example. The user is authenticated in block 304 using a multifactor authentication to confirm their identification. The user then issues a command or control action in block 306. In an embodiment, the method 300 checks to see if a flag, sometimes referred to as a “Duress Flag” has been set. The Duress Flag is another function that may be set by preauthorized users in particular situations. For example, if an unauthorized user has gained access to the control system, a system manager who is preauthorized, may set the flag to on. In some embodiments, the method of setting the flag may be independent of the hardware and software of the control center. In an embodiment, the flag may not be reset without a preauthorized person issuing the command or activating hardware (e.g. require a physical key). When the flag is set, control transactions for changing the operation of the may not be transmitted.

In this embodiment, the method 300 may operate on a series of rules that identify undesired operating condition. It should be appreciated that while the embodiment of provides query blocks 308, 310, 312 as examples, in other embodiments the method may check the control-action/command against more or fewer rules. In an embodiment, the control-action/commands against which the method checks may be user-defined by the system operator for example.

In query block 308, the method 300 determines whether the control action will result in a load shedding event. As used herein, a load shedding is a system whereby the electrical utility can either disconnect or alter the operation of equipment (e.g. loads) at a customer's facility under certain conditions. For example, some electrical utilities have a program that allows them increase a temperature on an air conditioning thermostat to reduce energy consumption. When the query block 308 returns a negative (no load shedding), the method 300 proceeds to query block 310 where it is determined whether the control action will result in a partial or complete shutdown of the electrical distribution network. When the query block 310 returns a negative (no network shutdown), the method proceeds to query block 312.

In query block 312, the control action is evaluated to determine if the settings of a piece of equipment, such as disconnect equipment 40, 130 for example, is set to an undesired condition. In an embodiment where the equipment 40, 130 is a recloser device for example, an undesired setting may be to have the device lock open (e.g. disconnect electrical service) in response to a single tripping condition. In the case of a recloser device, this may be undesired because it may comprise the intended purpose of the device. In the case of a recloser device, it is intended to open and reclose multiple times in an attempt to automatically clear a fault that occurs on the system (e.g. a branch that falls on the powerline). When the query block 312 returns a negative (no undesired device setting change), the method 300 proceeds to block 314 where the control action is continued to be executed. It should be appreciated that once authentication has been confirmed, the system continues the execution of the command signal, including any additional processes or methods that would have been performed as part of the execution process. As used herein, the execution of a command does not mean the command will be immediately executed.

When query blocks 308, 310 return a positive, meaning a load shedding event or network shutdown will occur, the method 300 proceeds to block 316 where an authentication process is initiated. In an embodiment, when query block 312 returns a positive, the method 300 proceeds to query block 318 where it is determined if the user is issued a number of control actions greater than a threshold within a predetermined amount of time. When query block 318 returns a negative, the method 300 proceeds to continue the execution of the control action in block 314. When the query block 318 returns a positive, the method 300 once again loops to block 316 where an authentication process is initiated.

The authentication block 316 may be a multifactor authentication as described herein. The method 300 then proceeds to block 320 where authentication is confirmed, such as by the user providing a password (knowledge factor) and a scans their thumb with a fingerprint readers (inherence factor) for example. When the query block 320 returns a positive (i.e. user authentication check is satisfied), then the method 300 loops back to block 314 and control action is continued to be executed. When the query block 320 returns a negative (i.e. user authentication check is not satisfied), then the method 300 proceeds to block 322 and the control action is terminated/rejected, the attempt to perform the control action is logged (e.g. in a database) and optionally an alarm is activated to alert other operators at the attempt to perform the control action.

It should be appreciated that the method 300 provides advantages in allowing a system operator to select which control-actions/commands to utilize the authentication stem. The control-actions/commends may be selected based on risk based criteria that takes into consideration a number of factors, such as but not limited to criticality of the equipment or the portion of the network, the sensitivity of the network, the impact on the network as a whole, and dynamic responses of the network for example.

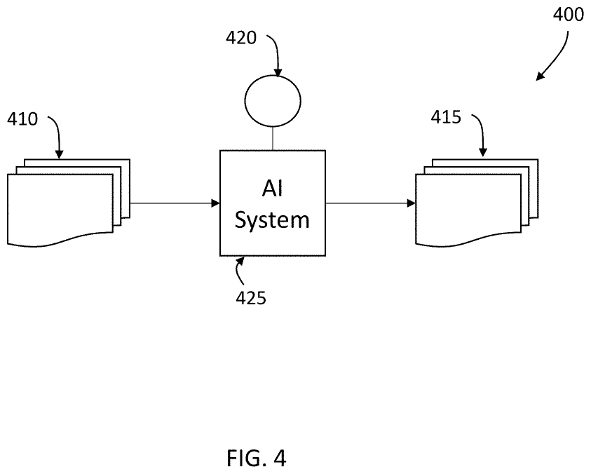

In some embodiments, the determination of the severity of impact of a control action (such as impact engine 206 for example) may be determined using a machine learning or artificial intelligence system. FIG. 4 depicts a block diagram of a system 400 for providing control action impact evaluation according to one or more embodiments. The system 400 includes a human operator 420 that trains the AI system 425. The training includes receiving multiple instances of control actions and network parameters 410 at the time the control action was taken. Network parameters may include system settings, equipment settings, load balances, supply availability and the like. During a training phase, the operator 420 indicates to the AI system 425 the operation of the network 415 after the control action was performed and whether the control action had an undesired impact (e.g. loss of service, unexpected network response). The operator 420 further indicates why there was an undesired or desired impact. In one or more embodiments, such reasoning can be provided by the operator 420 changing the network parameters (e.g. equipment settings) to correct the undesired impact (e.g. restore service to customers).

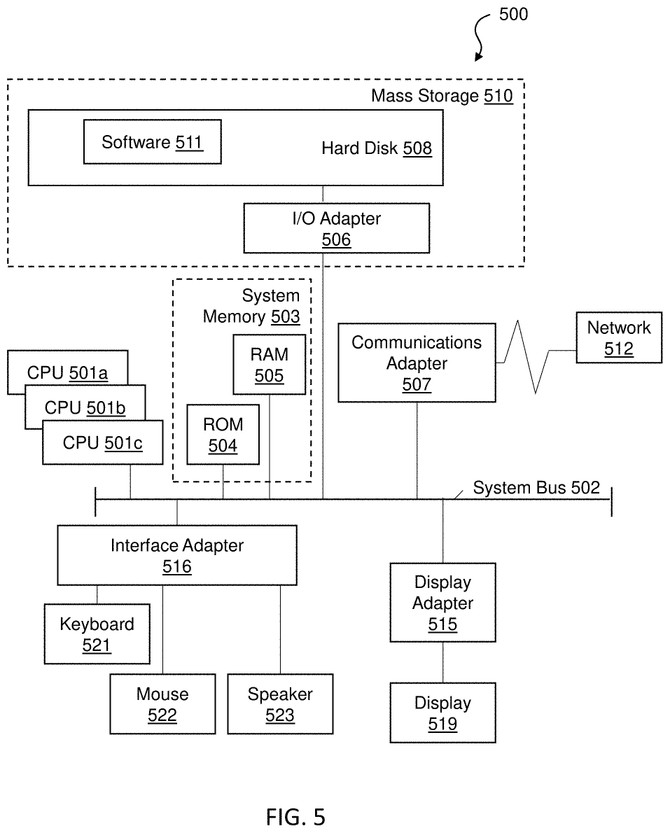

Turning now to FIG. 5, a computer system 500 is generally shown in accordance with an embodiment. The computer system 500 can be an electronic, computer framework comprising and/or employing any number and combination of computing devices and networks utilizing various communication technologies, as described herein. The computer system 500 can be easily scalable, extensible, and modular, with the ability to change to different services or reconfigure some features independently of others. The computer system 500 may be, for example, a server, desktop computer, laptop computer, tablet computer, or smartphone. In some examples, computer system 500 may be a cloud computing node. Computer system 500 may be described in the general context of computer system executable instructions, such as program modules, being executed by a computer system. Generally, program modules may include routines, programs, objects, components, logic, data structures, and so on that perform particular tasks or implement particular abstract data types. Computer system 500 may be practiced in distributed cloud computing environments where tasks are performed by remote processing devices that are linked through a communications network. In a distributed cloud computing environment, program modules may be located in both local and remote computer system storage media, including memory storage devices.

As shown in FIG. 5, the computer system 500 has one or more central processing units (CPU(s)) 501a, 501b, 501c, etc. (collectively or generically referred to as processor(s) 501). The processors 501 can be a single-core processor, multi-core processor, computing cluster, or any number of other configurations. It should be appreciated that the computer system 500 may be virtualized. The processors 501, also referred to as processing circuits, are coupled via a system bus 502 to system memory 503 and various other components. The system memory 503 can include a read only memory (ROM) 504 and a random access memory (RAM) 505. The ROM 504 is coupled to the system bus 502 and may include a basic input/output system (BIOS), which controls certain basic functions of the computer system 500. The RAM is read-write memory coupled to the system bus 502 for use by the processors 501. The system memory 503 provides temporary memory space for operations of said instructions during operation. The system memory 503 can include random access memory (RAM), read only memory, flash memory, or any other suitable memory systems.

The computer system 500 comprises an input/output (I/O) adapter 506 and a communications adapter 507 coupled to the system bus 502. The I/O adapter 506 may be a small computer system interface (SCSI) adapter that communicates with a hard disk 508 and/or any other similar component. The I/O adapter 506 and the hard disk 508 are collectively referred to herein as a mass storage 510.

Software 511 for execution on the computer system 500 may be stored in the mass storage 510. The mass storage 510 is an example of a tangible storage medium readable by the processors 501, where the software 511 is stored as instructions for execution by the processors 501 to cause the computer system 500 to operate, such as is described hereinbelow with respect to the various Figures. Examples of computer program product and the execution of such instruction is discussed herein in more detail. The communications adapter 507 interconnects the system bus 502 with a network 512, which may be an outside network, enabling the computer system 500 to communicate with other such systems. In one embodiment, a portion of the system memory 503 and the mass storage 510 collectively store an operating system, which may be any appropriate operating system, such as the z/OS or AIX operating system from IBM Corporation, to coordinate the functions of the various components shown in FIG. 5.

Additional input/output devices are shown as connected to the system bus 502 via a display adapter 515 and an interface adapter 516 and. In one embodiment, the adapters 506, 507, 515, and 516 may be connected to one or more I/O buses that are connected to the system bus 502 via an intermediate bus bridge (not shown). A display 519 (e.g., a screen or a display monitor) is connected to the system bus 502 by a display adapter 515, which may include a graphics controller to improve the performance of graphics-intensive applications and a video controller. A keyboard 521, a mouse 522, a speaker 523, etc. can be interconnected to the system bus 502 via the interface adapter 516, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI). Thus, as configured in FIG. 5, the computer system 500 includes processing capability in the form of the processors 501, and, storage capability including the system memory 503 and the mass storage 510, input means such as the keyboard 521 and the mouse 522, and output capability including the speaker 523 and the display 519.

In some embodiments, the communications adapter 507 can transmit data using any suitable interface or protocol, such as the internet small computer system interface, among others. The network 512 may be a cellular network, a radio network, a wide area network (WAN), a local area network (LAN), or the Internet, among others. An external computing device may connect to the computer system 500 through the network 512. In some examples, an external computing device may be an external web server or a cloud computing node.

It is to be understood that the block diagram of FIG. 5 is not intended to indicate that the computer system 500 is to include all of the components shown in FIG. 5. Rather, the computer system 500 can include any appropriate fewer or additional components not illustrated in FIG. 5 (e.g., additional memory components, embedded controllers, modules, additional network interfaces, etc.). Further, the embodiments described herein with respect to computer system 500 may be implemented with any appropriate logic, wherein the logic, as referred to herein, can include any suitable hardware (e.g., a processor, an embedded controller, or an application-specific integrated circuit, among others), software (e.g., an application, among others), firmware, or any suitable combination of hardware, software, and firmware, in various embodiments.

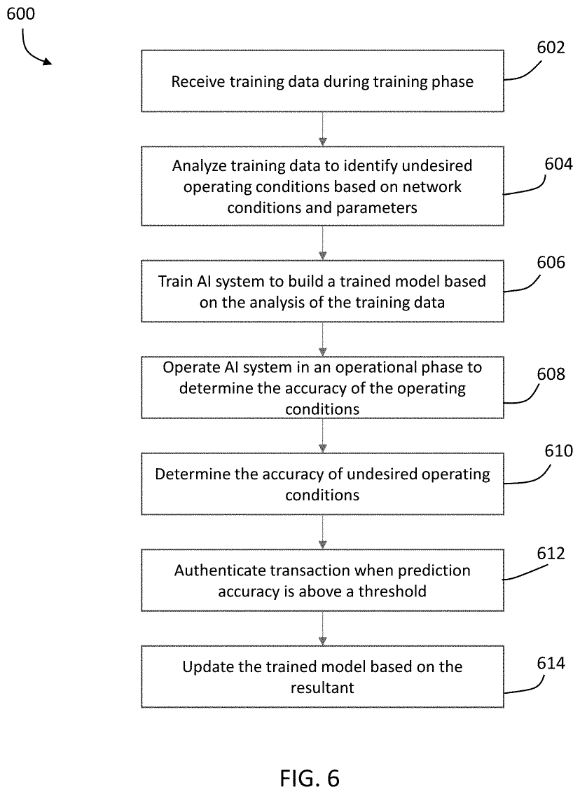

FIG. 6 depicts a flow diagram of a method 600 for training the AI system for supporting electrical distribution network operations and prevent, reduce the risk of, or reduce the severity of undesired network operating conditions (e.g. loss of service to customers or damage to equipment). The method 600 starts in block 602 by receiving by the AI system 425, training data for teaching the AI system 425 desired and undesired operating conditions for the electrical distribution network. It should be appreciated that the training data may include historical data that recorded network parameters when an undesired event occurred for example.

The method 600 of training the AI system 425 may further include identifying, by the operator 420, undesired conditions that did not result in a loss of service or damage to equipment. Such undesired conditions may include voltage drops or sagging for example. The training may further include examples of corrective actions that were taken (e.g. other control actions) in response to an undesired operating condition. These conditions are analyzed in block 604.

As the operator 420 identifies undesired conditions the occur, or potential undesired conditions that could occur if a particular control action is performed, the AI system 425 is trained to recognize patterns of undesired conditions by such supervised training. It should be noted that the operator 420 can mark potential undesired conditions that may occur if a particular control action is performed, without actually performing the control action The training data further includes the desired condition, i.e. the expected operating condition or state. The AI system 425 generates a model that can determine the accuracy an electrical network operating conditions based on the training at block 606.

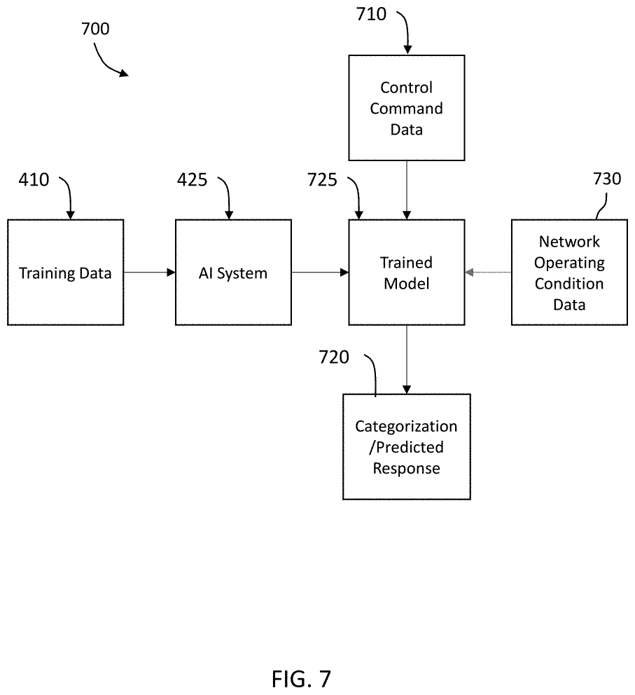

FIG. 7 depicts an example block diagram of the supervised training of the AI system according to one or more embodiments of the present invention. The AI system 425 creates the trained model 725 based on the training data 410 from the operator 420. Once trained, the trained model 725 can be used to provide categorization 720 of the command or control action 710 based on current network operating conditions or parameters 730 that are input to the trained model 725. The control action 710 and network operating condition data may be collectively referred to as “live data.” The control action 710 is categorized according to the perceived accuracy of the network response by the trained model 725. The control actions are not labeled by the operator 420, and in one or more embodiments, not even seen by the operator 420 prior to being input to the AI system 425.

Once the model 725 is trained, the method 700 further includes operating the AI system 425 in an operational phase to determine the accuracy of registration in live data, at block 608 (FIG. 6). In the operational phase, the AI system 425 receives one or more control actions 710 from a user. The control action(s) 710 do not include any labels that identify potential electrical distribution network responses.

Accordingly, the AI system 425, by using the trained model 725, can determine the electrical distribution system response to the control action(s) 710, at block 608. The network response is determined as the classification output/categorization 720 of the trained model. The AI system 425 supports the operator 420, from an inexperienced user to an experienced user, during network operation, which can be complicated unusual situations, equipment malfunctions, maintenance operations, weather conditions, or any other such factors. The AI system 425 checks system response and creates an evaluation of the accuracy of the predicted response, at block 610. The evaluation is a quality parameter of the estimated network response. In one or more embodiments of the present disclosure, the AI system 425 creates one of three levels of notification for an operator/user. For example, if the predicted response occurs, the AI system 425 provides the operator with a passing notification. For example, a specific colored notification, such as green color, specific icon, or any other notification that represents that the predicted network response is verified as accurate.

Alternatively, if the predicted network response is inaccurate (e.g. the electrical distribution network), the AI system 425 provides a notification that indicates a failure such as a red-colored notification, a specific icon, or any other such failure notification. In another alternative case, if a confidence level in the predicted network response does not exceed a predetermined threshold, the AI system 425 provides a ‘maybe’ notification. For example, the maybe notification can be represented by a specific colored notification, such as yellow, or a specific icon, or any other such representation.

Furthermore, the AI system 425 creates flags in the user interface that identify portions in the network distribution system map where the AI system 425 has identified that the predicted network response is not accurate. The flags can be visual notifications of the specific portions in the map, such as circles, icons, or any other user interface indication. The operator 420 can switch through these flags and decide if the warning of the AI system 425 is reasonable or unreasonable. The visual attributes include color, size, icon, image, or any other such attribute used to render the flag on the visual depiction of the electrical distribution network.

Further, the input from the operator 420 is not only used to improve the registration but also to train the AI system 425 further with the new registration data. The updates from the operator 420 are input as additional training data into the AI system 425, which tweaks the trained model 725 further based on such training data.

The one or more embodiments of the present disclosure can accordingly support the operator 420 to create improved results with the generated model or point cloud of the environment.

The AI system 425, in one or more embodiments of the present disclosure, uses a convolutional neural network (CNN) that is used to progressively extract higher- and higher-level representations of the network responses in a complex electrical distribution network. Instead of preprocessing the data to derive predicted responses, the CNN learns how to extract network responses, and ultimately infer whether a control action or set of control actions will result in an undesired operating condition. The CNNs can use a Rectified Linear Unit (ReLU) transformation to introduce nonlinearity in the trained model 725.

In one or more embodiments of the present disclosure, the trained model 1025 can be created using a classification model that provides the categorization 1020 as “Accurate network response” or “Inaccurate network response,” or “Pass” or “Fail.” Classification Models are used to predict the category of the control action 710. Alternatively, the trained model 725 is a regression model that is used to determine the categorization 720 as a real value, such as a fitting value by which the predicted network response is not accurate, for example. The regression model can be linear regression, logistic regression, polynomial regression, ridge regression, or any other such regression model.

It should be noted that other supervised machine learning techniques can be used to build the trained model 725 apart from the techniques described herein.

Technical effects and benefits of the disclosed embodiments include, but are not limited to, monitoring control actions issued by a user on a network and selectively preventing execution of the control action to prevent or reduce the risk of an undesired operating condition based on a predicted network response unless the user is authenticated.

The term “about” is intended to include the degree of error associated with measurement of the particular quantity based upon the equipment available at the time of filing the application. For example, “about” can include a range of ±8% or 5%, or 2% of a given value.

One or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In one aspect, the computer-readable storage medium may be a tangible medium containing or storing a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium, and that can communicate, propagate, or transport a program for use by or in connection with an instruction execution system, apparatus, or device.

The computer-readable medium may contain program code embodied thereon, which may be transmitted using any appropriate medium, including but not limited to wireless, wireline, optical fiber cable, RF, etc., or any suitable combination of the foregoing. In addition, computer program code for carrying out operations for implementing aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server.

It will be appreciated that aspects of the present invention are described herein with reference to flowchart illustrations and/or block diagrams of methods, apparatus (systems) and computer program products according to embodiments of the invention. It will be understood that each block or step of the flowchart illustrations and/or block diagrams, and combinations of blocks or steps in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

Terms such as processor, controller, computer, DSP, FPGA are understood in this document to mean a computing device that may be located within an instrument, distributed in multiple elements throughout an instrument, or placed external to an instrument.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description but is only limited by the scope of the appended claims.

What is claimed is:

1. A method of operating a utility system having a plurality of equipment for controlling the operation of the utility system, the method comprising:
receiving, from a user, a control action for at least one of the plurality of equipment;
determining an impact of the control action on the operation of the utility system;
determining based at least in part on the impact of the control action that a predetermined condition may occur as a result of executing the control action; and
performing an authentication check on the user prior to executing the control action.

2. The method of claim 1, further comprising terminating the control action when the authentication check is not satisfied.

3. The method of claim 2, further comprising activating an alarm when the authentication check is not satisfied.

4. The method of claim 2, further comprising further comprising generating a log entry in a database when the authentication check is not satisfied.

5. The method of claim 1, wherein the predetermined condition is a load shedding event.

6. The method of claim 1, wherein the predetermined condition is a network shutdown.

7. The method of claim 1, wherein the predetermined condition is a single event disconnect for at least one of the plurality of equipment.

8. A method of claim 7, further comprising determining when the user has issued greater than a predetermined number of control actions within a predetermined number of minutes.

9. The method of claim 8, further comprising performing the authentication check when the user has issued greater than the predetermined number of control actions within the predetermined number of minutes.

10. The method of claim 1, wherein the determining the impact of the control action is performed by artificial intelligence system, the artificial intelligence system being based on a trained model.

11. The method of claim 10, further comprising training of the artificial intelligence system to determine an impact of a control action.

12. The method of claim 1, wherein the training comprises:
receiving training data that comprises control actions, utility system parameters, utility system conditions prior to the execution of the control action, and utility system conditions after execution of the control action;
creating a model to predict the predetermined condition by analyzing the training data;
evaluating utility system conditions in live data received from the utility system based on the trained model by the artificial intelligence system, the live data including control actions and utility system conditions; and
outputting a result of the evaluation of the utility system conditions after execution of the control action, the result identifying a probability level of a predetermined condition occurring.

13. The method of claim 12, wherein the training further comprises supervised training.

14. The method of claim 1, wherein the authentication check comprises using multifactor authentication.

15. A utility system comprising:
a plurality of control equipment coupled to the utility system;
a plurality of sensors coupled to the utility system; and
one or more processors operably coupled to the plurality of control equipment and a plurality of sensors, wherein the one or more processors are operable to:
receive, from a user, a control action for at least one of the plurality of equipment;
determine an impact of the control action on the operation of the utility system;
determine, based at least in part on the impact of the control action, that a predetermined condition may occur as a result of executing the control action; and
perform an authentication check on the user prior to executing the control action.

16. The utility system of claim 15, wherein the one or more processors are further operable to activate an alarm when the authentication check is not satisfied.

17. The utility system of claim 15, wherein the predetermined condition includes at least one of a load shedding event, a network shutdown, and a single event disconnect of one of the plurality of equipment.

18. The utility system of claim 15, the determining the impact of the control action is performed by artificial intelligence system, the artificial intelligence system being based on a trained model.

19. The utility system of claim 18, wherein a training of the artificial intelligence system comprising:
receiving training data that comprises control actions, utility system parameters, utility system conditions prior to the execution of the control action, and utility system conditions after execution of the control action;
creating a model to predict the predetermined condition by analyzing the training data;
evaluating utility system conditions in live data received from the utility system based on the trained model by the artificial intelligence system, the live data including control actions and utility system conditions; and
outputting a result of the evaluation of the utility system conditions after execution of the control action, the result identifying a probability level of a predetermined condition occurring.

20. The utility system of claim 19, wherein the utility system parameters and utility system conditions are based at least in part on signals from the plurality of sensors.
